(19) United States
(12) Patent Application Publication
(10) Pub. No.: US 2003/0067919 A1
(43) Pub. Date: Apr. 10, 2003

(54) Labeled analog burst switching for any high-layer-over-signal channel integration

(76) Inventors: Chunming Qiao, Williamsville, NY (US); John Staley, Dallas, TX (US)

Correspondence Address: LIEBERMAN & NOWAK LLP, 350 FIFTH AVE., SUITE 7412, NEW YORK, NY, 10118, US

(21) Appl. No.: 10/264,916

(22) Filed: Oct. 4, 2002

Related U.S. Application Data
(60) Provisional application No. 60/327,121, filed on Oct. 4, 2001.

(51) Int. Cl. H04L 12/28; H04J 3/16

(52) U.S. Cl. 370/392; 370/474

(57) ABSTRACT

An integrated network architecture called Labeled Analog Burst Switching (LABS) using enhanced/extended MPLS as a control plane and extended Optical Burst Switching as a switching paradigm that avoids the need for buffer memory or other data delay devices at intermediate nodes is proposed. The structure of a LABS node and the AP interface between an edge LABS node and protocol data unit devices such as electronic LSR's are proposed, so are the structure of a LABS control packet, burst assembly/disassembly methods, methods for fault detection/localization and recovering from lost bursts, and LABS specific information for distribution using extended IGP protocols for traffic engineering.

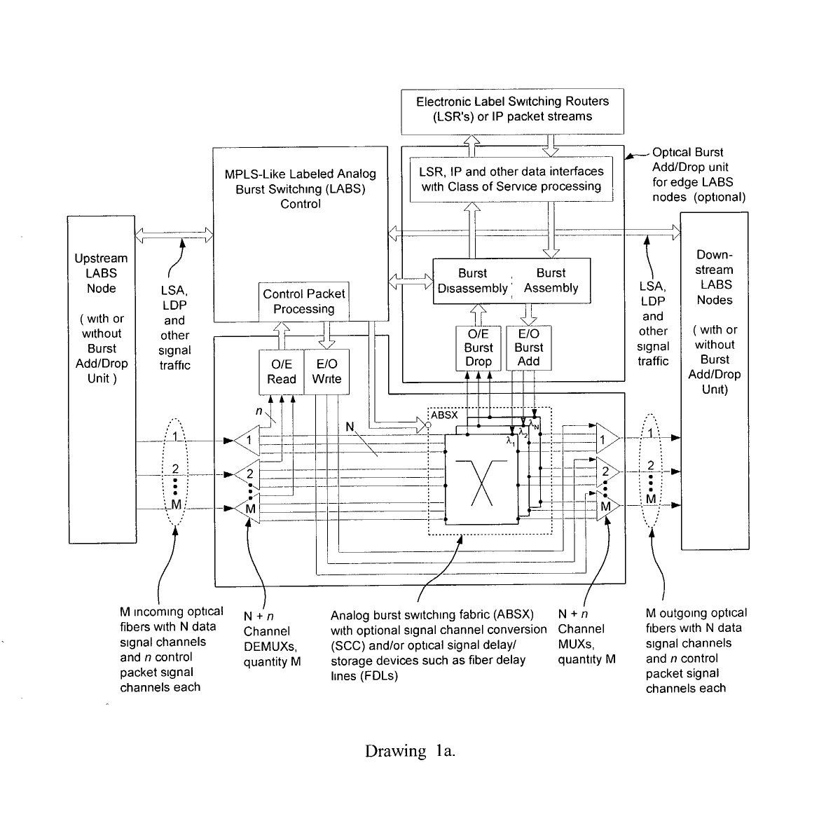

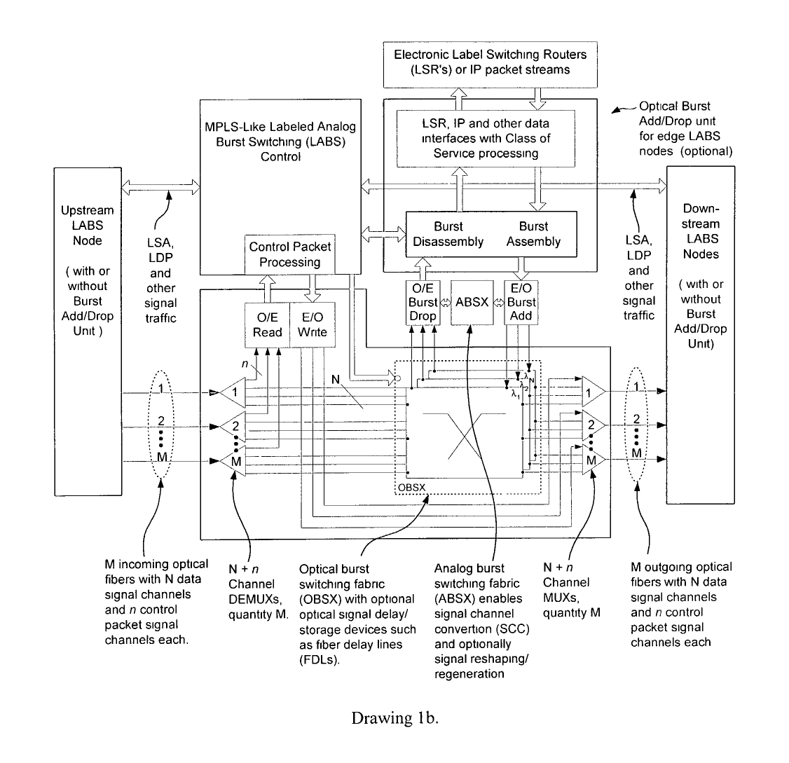

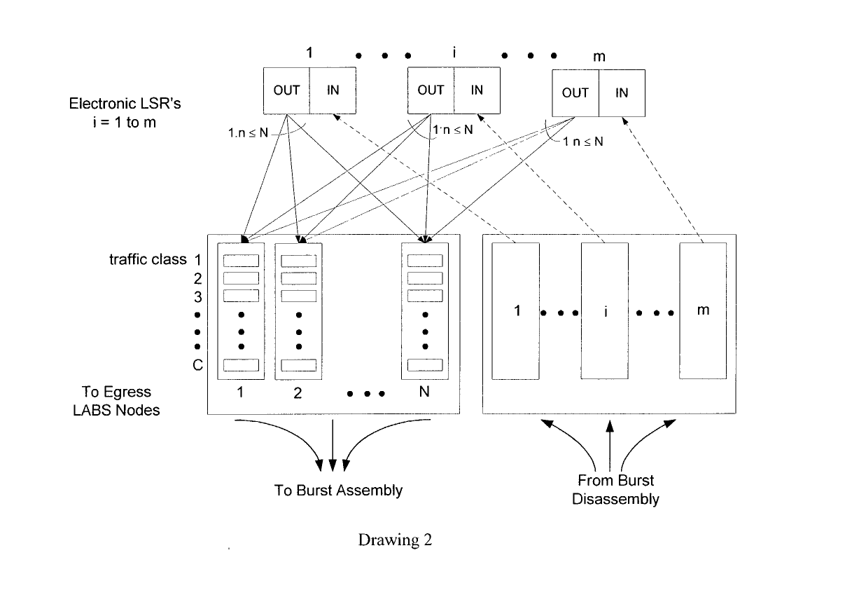

### REFERENCE TO RELATED APPLICATIONS

This application claims the filing date of Provisional Application No 60/327,121 filed on Oct. 4, 2001.

### FIELD OF THE INVENTION

The current invention relates to the field of fiber-optic networks for telecommunications and data communications, in particular a network architecture integrating any high-layer protocols (AHL) and any signal channel (SC) layers, or AHL-over-SC of which, IP-over-WDM is an example.

### BACKGROUND OF THE INVENTION

Recently, Labeled Optical Burst Switching (LOBS) was developed as a network architecture solution that utilizes Internet Protocol over Wavelength-Division Multiplexing (IP-over-WDM) as the core architecture for the next generation Optical Internet. The inventors of the instant application previously filed patent applications for “Labeled Optical Burst Switching for IP-over-WDM integration,” U.S. patent application Ser. No. 09/817,471 filed on Mar. 26, 2001, based on provisional application No. 60/269,005 filed on Feb. 15, 2001; “Method to Process and Forward Control Packets in OBS/LOBS and Other Burst Switched Networks”, U.S. patent application Ser. No. 10/104,843 filed on Mar. 22, 2002, based on provisional application 60/279,315 filed on Mar. 28., 2001; and “Method to Control a Special Class of OBS/LOBS and Other Burst Switched Devices”, U.S. patent application Ser. No. 10/097,227, based on provisional application No. 60/279,315 filed on Mar. 28,2001. The above-referenced applications are hereby incorporated by reference as if fully set forth herein.

LOBS is a better solution than prior solutions such as Optical Burst Switching, Wavelength-Routing, Multi-Protocol Lambda Protocol and Optical Packet Switching. By integrating the IP layer with the WDM layer in order to reduce redundancies in software and hardware, LOBS can improve efficiency, facilitate traffic engineering and network survivability, interoperate on multi-vendor systems, work between heterogeneous networks, as well as having the potential for migration to optical packet-switched networks of the future.

LOBS relies on fast, all-optical switching fabrics to perform forwarding of in-band data bursts. One potential shortcoming of this approach is that fast all-optical switching fabrics have only recently become commercially available and they may have problems achieving either cost targets, the necessary ability to scale, or their supply may simply be limited. Additionally, currently available optical switching fabrics may not have optional features such as wavelength conversion or signal delay/storage capabilities.

It is, therefore, an object of the current invention to extend the Labeled Optical Burst Switching network architecture to a special class of analog switching nodes called Labeled Analog Burst Switching (or LABS) nodes. Fast optical switching nodes (as required by LOBS) are members of this special class.

A further object of the invention to optionally include the features of signal channel (eg. wavelength) conversion and signal delay/storage capabilities in this special class of analog switching fabric.

It is a another object of the invention to extend the use of this special class of analog switching fabrics to all out-of-band control packet based Burst Switching architectures such as Optical Burst Switching or Optical Packet Switching. It is also an object of this invention to extend this architecture to all Signal Channel (SC) data transport schemes, containing one or more signal channels, of which WDM is an example.

It is finally an object of this invention to extend the functional architecture of a LOBS node to multiple LABS node architectures.

### SUMMARY OF THE INVENTION

The above and related objectives are achieved by building on the teaching of LOBS for an integrated IP-over-WDM networking architecture. The invention expands the teachings to a general networking architecture that integrates any high layer protocols and any signal channel (SC) layer protocols by utilizing a novel node structure called an Labeled Analog Burst Switch or LABS, and using Multi-Protocol Label Switching (MPLS) and LABS specific extensions as the control platform and ABS as the data switching/transport mechanism.

A LABS node is similar to a MPLS label-switched router (LSR) and handles control packets (which contains a label as a part of the control information), and data bursts (each of which can be formed by assembling IP packets, Ethernet frames, ATM cells or other protocol data units going from a common ingress LABS node to the same egress LABS node). Specifically, the LABS control plane sets up label switched paths, called LABS paths, for the control packets and their corresponding data bursts. In a LABS network, both explicit routing (ER) and constraint-based routing (CBR) can be used to provision and engineer network resources. Modified/extended interior gateway protocols (IGP) can be used to disseminate resource/topology information for avoiding contentions for the same wavelength channel among bursts belonging to different LABS paths. Finally, network availability concerns can be addressed using the emerging MPLS survivability framework (i.e., alternate/backup channels).

### DESCRIPTION OF DRAWINGS

Drawing 1a and 1b depicts exemplary Labeled Analog Burst Switching Nodes.

Drawing 2 depicts the Access Point interface between protocol data unit (PDU) devices (e.g., electronic LSR) and LABS nodes.

### DETAILED DESCRIPTION OF THE INVENTION

In a preferred embodiment of the invention, the network backbone will consist of LABS nodes (of which a LOBS node is a special type of LABS node), including edge (both ingress and egress) LABS nodes and core LABS nodes. LABS is distinguished from LOBS in that a LABS node contains an Analog Burst Switching Fabric (ABSX), as opposed to the Optical Burst Switching Fabric (OBSX) found in a LOBS node. Further, in LABS inter-node control packet and data burst physical transport can occur over any Independent Optical Channel (IOC) scheme, whereas LOBS is constrained to Wavelength Division Multiplexing (WDM). LABS nodes that are interconnected via WDM physical transports can inter-operate with LOBS nodes within the network.

An ABSX allows optical-to-quanta-to-optical (OQO) conversion within the burst switching fabric as long as the conversion and the signal propagation (in the absence of jitter and other physical system perturbations), satisfies the following criteria:

i) The ABSX does not require the use of signal delay devices such as electronic buffer memory, optical buffer memory, fiber delay loops (FDLs) or other similar devices in order to propagate a data burst from an arbitrary input port of the ABSX to an arbitrary output port of the ABSX;

ii) The ADSX does not require the use of signal channel (eg. wavelength) conversion;

iii) The activation time (a), Switching time (s), transition time (t), minimum dwell time (d) and switching cycle time (c) of the allowed state changing operations of the ABSX shall conform to the definitions of Fast, LAST or LAST+;

iv) The time for a signal to propagate from a given ABSX input port (i), across a given signal path (k) within the ABSX, and to a given ABSX output port (j) is:

a) in the absence of delay devices such as FDLs, t₁ⱼₖ=constant;

b) in the presence of delay devices such as FDLs with total delay time(s) t_{d}, t′₁ⱼₖ=t₁ⱼₖ+t_{d} where t_{d} represents an element from the set of delay times possible from the delay device(s) present; and

v) The physical carrier may be photons, electrons, phonons, or any other signal propagating quanta.

In contrast, OBSX, while in all other respects is the same as an ABSX, only allows photons to be the physical carrier of signal within the switch fabric (i.e.,. OBSX is an optical-optical-optical (OOO) switch fabric).

A LABS node (showing both edge and core nodes) is shown in Drawing 1a and 1b. Referring to Drawing la: Signal channel conversion and delay devices are optional within the ABSX. If the quanta of the ABSX is chosen to be electrons, then signal channel (eg. wavelength) conversion is easily accomplished by directing the optical signal from an input port via an electronic signal to an optical output port with the desired output signal channel (wavelength).

Drawing 1b illustrates how a LABS node can accomplish signal channel (wavelength) conversion by the addition of an ABSX external to a core OBSX. If the core OBSX does not have signal channel (wavelength) conversion capabilities, signal channel (wavelength) conversion can be accomplished without delaying devices by directing the burst to a drop port, and then redirecting the burst via the ABSX (with or without the optional signal channel conversion capability), to an add-port of the OBSX with the desired new signal channel (wavelength). Then, the ABSX quanta could be electrons transmitting the burst from the Optical-to-Electrical conversion of the drop port, to the Electronic-to-Optical conversion of the add port. Upon re-entering the OBSX, the burst now at its new signal channel (wavelength), and would then exit the OBSX at the desired output port. The preceding discussion is exemplary and does not proscribe that the ABSX quanta to be as per the discussion.

Referring to Drawing 1: The access point (AP) interface (1), burst assembly/disassembly functions (2) and LABS data add/drop functions (3), are needed for edge LABS nodes only. These are optional for core LABS nodes. (In Drawing 1, (1), (2) and (3) are collectively grouped as being optional (4) for core LABS.) FDLs and signal channel (eg. wavelength) conversion capability are optional but preferred at core LABS nodes. LABS nodes are interconnected with WDM links, each of which contains one or more control wavelengths, and one or more data wavelengths.

At the access point, PDU devices (5) will be attached to an edge LABS node. PDUs from these devices are assembled into “bursts” at an ingress LABS node, and then delivered, in burst switched mode, to an egress LABS node without going through any signal delaying operations at intermediate (i.e., core) LOBS nodes. Note that the data burst can undergo optical/electrical/optical or other physical conversions so long as the burst propagates without requiring the presence of memory or other delay devices within whatever media it may be traveling in. The egress LOBS node then disassembles each burst and forwards PDUs to appropriate PDU devices.

Turning to the AP interface between PDU devices and LABS nodes (6): The traffic coming out of PDU devices are likely to be streams of packets (most probably IP packets) carrying various labels, where each label is associated with a specific class of service, and a specific LSP destined to a specific egress LSR attached to an egress LABS node.

In the preferred embodiment, the interface unit will contain multiple burst assembly/burst disassembly (BA/BD) buffers, one for each egress LABS node. Each BA buffer would be divided into multiple queues, one for each Class of Service, with specific delay, loss probability and other Quality of Service (QoS) parameters. See Drawing 2. A primary function of the interface unit is to map PDUs to a corresponding BA buffer, where the PDUs are to be assembled into bursts that will be sent on one or more LABS paths. Multiple LSPs may be mapped onto the same LABS path (i.e., aggregated), provided that these LSPs are all destined to the same egress LABS node (but possibly different egress PDU devices such as electronic LSRs attached to the LABS node), and the LABS path provides compatible (or better) services than required by these LSPs.

PDUs in a BA buffer are assembled into a burst by adding guard bands at each end. Each PDU retains its MPLS label, if any. A PDU's “maximum delay budget” is defined as the maximum time allowed for a PDU, in the absence of in-traversal PDU loss, to travel from an ingress LABS node to an egress LABS node. PDUs belonging to different classes of service may have different maximum delay budgets. A PDU will either be assembled into a burst or the following burst, so that the PDU will not be fragmented. Assembly of a burst is considered to be complete if its length (in bits or bytes) exceeds a threshold, or if the remaining delay budget of a PDU in the burst reaches zero. Other burst assembly algorithms are also possible.

Another function of the interface unit is to disassemble and distribute the bursts entering on different LABSs paths. Burst disassembly is performed by the removal of the guard bands. After burst disassembly, PDUs packets (with their MPLS labels) are stored in appropriate BD buffers (which are structured similarly to BA buffers) and then forwarded to egress PDU devices such as electronic LSRs.

After a burst is assembled, an ingress LABS node constructs a control packet that contains a MPLS header (i.e., 32 bits including a 20 bit label), a basic offset time, an extra offset time for QoS support, and the burst. The label in the MPLS header corresponds to a LOBS path. (How the path is determined is described in further detail below). The control packet will then be transmitted over a control wavelength (signal channel) along the same physical route as that to be taken by the burst along the LABS path. The corresponding burst is transmitted via the LABS add/drop unit after the offset time specified by the control packet. Each control wavelength (signal channel) is terminated (i.e., the signals go through O/E/O conversions) at every LABS node, where the control packet is processed electronically.

At an intermediate LABS node, the bandwidth on an outgoing data signal channel (wavelength) is reserved (optionally, a signal delay and/or a signal channel converter will also be reserved) for the corresponding burst, and the burst switching fabric inside the LABS node will be configured just before the offset time specified by the control packet (i.e., the expected burst arrival time).

The control packet may carry a new label as a result of performing the label push/pop/swap function as defined in MPLS. The offset time value is adjusted down to account for any processing delays the control packet experienced at this node. If the bandwidth reservation/switch configuration is successful, the control packet is transmitted to the next LABS node. When a control packet arrives at an egress LABS node, it is processed to configure the LABS add/drop unit (among other tasks), and then discarded. The corresponding burst is received via the add/drop unit by the BD buffer. If, however, the bandwidth reservation/switch configuration at an intermediate LABS node is unsuccessful, the control packet will be dropped, and a negative acknowledgment (NAK) packet will be sent to the ingress LABS node. Copies of the PDUs belonging to the same Classes of Services will be kept at the ingress LABS node, which, upon receiving the NAK for the burst containing one or more of these “lost” PDUs, will reassemble the lost PDUs into one or more bursts and retransmit the bursts. The copy of a PDU may be discarded after the maximum round trip time of a burst control packet within the LABS network

We now turn to a discussion on how path determination is performed. LABS nodes will have IP addresses, and an Interior Gateway Protocol (IGP) such as OSPF (Open Shortest Path First) will be augmented/enhanced in order to disseminate the topology information. For example, new Link State Advertisements (LSA) packets will be used to carry information specific to LABS such as burst profiles and the amount of allocated and available FDLs at each node. The burst profile would include the average number and length of bursts that have successfully reserved bandwidth and FDLs, average and extra offset time used, average collision/dropping rate and so on. Based on the information obtained by the augmented IGP, a constraint based routing (CBR) or explicit routing (ER) algorithm will be used to determine the routes for LABS paths.

The criteria (or QoS parameters) to be used by the CBR/ER algorithm include the expected burst dropping probability and end-to-end latency. The former is dependent mainly on existing burst profiles, and the latter mainly on the total propagation delay between the node pair. The algorithm should, for example, distribute the load as evenly as possible among the links while trying to reduce the number of hops for each LABS path.

Once the route for a LABS path is determined by the CBR/ER algorithm, a constraint routing based label distribution protocol (CR-LDP) or an augmented RSVP protocol is used to establish the LOBS path. Basically, at an ingress LABS node, the protocol assigns one or more labels that are locally unique to each class of bursts going to an egress LABS node, and specifies the output link (and also the wavelength when there is no wavelength conversion at the next LABS node along the predetermined route). For a specific class of bursts between a node pair, a base offset time (at least its range), and an extra offset time (which can be increased or decreased on a network wide basis) will be determined.

At each intermediate LABS node, the CRLDP sets up a mapping between an incoming label on an incoming link to an (assigned) outgoing label and an outgoing link. At this time, signal channels may or may not be specified. When specifying signal channels, if the node doesn't have the signal channel conversion capability, the same signal channel as the one used by the incoming burst will be used on the output link. Otherwise, a different signal channel may be used. If signal channels are not specified by the CR-LDP, the control packet must contain the signal channel information and at each intermediate node, the output channel selected must be the same as the input channel if the node does not have signal channel conversion capability, but can be different otherwise. At an egress LABS node, an incoming label is mapped to a BD buffer corresponding to the class of services the label (or LABS path) is associated with. In addition, at an ingress LABS node, one or more electronic LSPs with equivalent class of services coming out of electronic LSR's (see Part A above) and going to the same egress LABS node are aggregated onto a LABS path belonging to that class of service, and disaggregated at the common egress LABS node. This is accomplished by pushing the electronic labels onto a label stack at the ingress LABS node, and then popping them out at the egress LABS node.

LABS network survivability issues are addressed based on extensions to several existing schemes for routing primary and backup LSPs. As in MPLS, primary and backup LABS paths are established. Since OBS allows for statistical multiplexing between bursts, this level of sharing is expected to yield even better efficiency in LABS networks than in wavelength-routed networks with similar approaches. For example, new protection schemes such as 1+n and n:1 may become possible, whereby a primary LABS path is protected by n backup LABS paths, each carrying a fraction (e.g. 1/n th) of the working traffic (bursts). More specifically, one may restore a primary LABS path by sending some bursts along the same backup route on a different signal channel (wavelength) or even along different backup routes. In such cases, the complexity associated with reordering bursts at the egress LABS node may increase (note that reordering bursts may be necessary even when 1:1 protection is used since a backup LABS path may be shorter than its corresponding primary LABS path). Additionally, idle resources for backup routes can also be used to carry lower-priority pre-emptable traffic (i.e. bursts), further improving network-level utilization. Compared to MPL(Lambda)S or wavelength-routed networks, restoration in LABS networks can be faster because rerouted burst can be sent without having to wait for acknowledgement that the signal channel switches/routers along the predetermined backup LSP have been configured properly.

As a solution to the problem of fault detection and localization, some form of electronic framing/monitoring can be used on embedded LABS control signal channels (wavelengths), since these are electronically terminated at each node. Also, monitoring can be done at each LABS node (i.e. on a hop-by-hop basis) without complex protocols of network level significance since LABS nodes will simply detect and localize fault events while MPLS signaling will restore service. LABS nodes can also adopt emerging techniques such as per link/channel monitoring of optical power levels received/transmitted, optical signal-to-noise ratios and so on to detect and localize faults, eliminating the need for any electronic frame monitoring altogether.

In comparing LABS with prior methods, we can see that LABS differs from MPL(Lambda)S in that in MPL(Lambda)S, a label is a wavelength, that is, only one label is mapped to a wavelength, and this mapping lasts for the duration of the label switched path (LSP). Also, data on two or more LSPs (each using a wavelength) cannot be groomed/aggregated onto one LSP (using one wavelength) because of a lack of useable wavelength merging techniques. Further, the underlying optical switch fabric at each node is a cross-connect (or wavelength router). However, under LABS, multiple labels can be mapped to a signal channel to achieve statistical sharing of the bandwidth of a signal channel among bursts belonging to different LABS paths. At each ingress LABS node, a LABS path can be mapped to different signal channels regardless of whether there is any signal channel conversion capability. With signal channel conversion at an intermediate node, a label (or a LABS path) may be mapped to different signal channels at different times as well.

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

What is claimed is:

1. A method for transmitting data over an optical network, comprising the steps of:
transmitting a first Protocol Data Unit (PDU) to an ingress labeled analog burst switching (LABS) node, said ingress LABS node having a Burst Assembly unit, a control packet processing unit, an analog burst switching fabric (ABSX) and is connected to at least one other LABS node,
passing said first PDU, including its label, to said Burst Assembly unit, said label determining an egress LABS node,
continuing to pass additional PDUs going to the same egress LOBS node as prior PDUs to said Burst Assembly unit until a pre-set threshold is met,
said Burst Assembly unit assembling an optical burst from the PDUs passed to it,
said control packet processing unit of the ingress LABS node constructing a analog burst switching control packet,
sending the optical burst switching control packet on a designated control wavelength to a LABS node either being an intermediate to the egress LABS node, or the egress LABS node,
performing optical signal to electrical signal conversion on the optical burst switching control packet at said intermediate node in order to set up a path using a data wavelength from the ingress LABS node to the egress LABS node, or at the egress node in order to drop the burst at the burst dis-assembly unit,
sending the optical data burst to the egress node along the pre-set path on a data signal channel in an optical burst switched mode without requiring burst delay devices such as FDLs or electronic memory or other buffer memories and without requiring signal channel conversion devices,
the egress LABS node receiving the optical data burst, said egress node having a burst dis-assembly unit,
passing the optical data burst to said burst dis-assembly unit, and
the burst dis-assembly unit converting the optical data burst to PDUs.

2. The method of claim 1, wherein the protocol data units are IP packets.

3. The method of claim 1, further comprising the steps of:
passing at least one additional protocol data unit going to the same egress LABS node as the first PDU to the Burst Assembly unit of the ingress LABS node.

4. A network for the transmission of data, comprising:
means for transmitting a first protocol data unit or PDU, such as an IP packet to an ingress labeled optical burst switching (LABS) node, said ingress LABS node having a Burst Assembly unit and a control packet processing unit, and is connected to at least one other LABS node,
means for passing said first PDU, including its label, to said Burst Assembly unit, said label determining an egress LABS node,
means for optionally passing at least one additional PDU going to the same egress LABS node as the first PDU to said Burst Assembly unit,
means for continuing to pass additional PDUs going to the same egress LABS node as prior PDUs to said Burst Assembly unit until a pre-set threshold is met,
means for said Burst Assembly unit assembling an optical burst from the PDUs passed to it,
means for said control packet processing unit of the ingress LABS node constructing a optical burst switching control packet,
means for sending the optical burst switching control packet on a designated control signal channel to a LABS node either being an intermediate to the egress LABS node, or the egress LABS node,
means for performing optical signal to electrical signal conversion on the optical burst switching control packet at said intermediate node in order to set up a path using a data signal channel from the ingress LABS node to the egress LABS node, or at the egress node in order to drop the burst at the burst dis-assembly unit,
means for sending the optical data burst to the egress node along the pre-set path on a data signal channel in an optical burst switched mode without requiring burst delay devices such as FDLs or electronic memory or other buffer memories and without requiring signal channel conversion devices at any intermediate node,
means for the egress LABS node receiving the optical data burst, said egress node having a burst dis-assembly unit,
means for passing the optical data burst to said burst dis-assembly unit, and
means for the burst dis-assembly unit converting the optical data burst to PDUs.

5. A network according to claim 4, in which the intermediate Labeled Analog Burst Switching Node comprises:
a Wavelength-Division Multiplexed Analog Burst Switch comprising an Analog Burst Switching Fabric and its controller, an input interface and an output interface; and
a control packet processing unit connected to the Signal Channel Multiplexed Analog Burst Switch, said processing unit utilizing as the control platform Multi-Protocol Label Switching in conjunction with LABS specific extensions.

6. A network according to claim 4, in which the ingress Labeled Analog Burst Switching Node comprises:
an Access Point interface connecting the ingress Labeled Analog Burst Switching Node to PDU devices such as electronic label switching routers,
a Burst assembly unit, and
a Signal Channel Multiplexed Analog Burst Switch comprising an Analog Burst Switching Fabric and its controller, an input interface and an output interface; and
a control packet processing unit connected to the Signal Channel Multiplexed Analog Burst Switch, said processing unit utilizing as the control platform Multi-Protocol Label Switching in conjunction with LABS specific extensions.

7. A network according to claim 4, in which the egress Labeled Analog Burst Switching Node comprises:
an Access Point interface connecting the Labeled Analog Burst Switching Node to PDU devices such as electronic label switching routers,
a Burst dis-assembly unit, and
a Signal Channel Multiplexed Analog Burst Switch comprising an Analog Burst Switching Fabric and its controller, an input interface and an output interface; and
a control packet processing unit connected to the Signal Channel Multiplexed Analog Burst Switch, said processing unit utilizing as the control platform Multi-Protocol Label Switching in conjunction with LABS specific extensions.

8. A Labeled Analog Burst Switching Node for network communications comprising:
a Signal Channel Multiplexed Analog Burst Switch comprising an Analog Burst Switching Fabric and its controller, an input interface and an output interface; and
a control packet processing unit connected to the Signal Channel Multiplexed Analog Burst Switch, said processing unit utilizing as the control platform Multi-Protocol Label Switching in conjunction with LABS specific extensions.

9. A Labeled Analog Burst Switching Node for network communications according to claim 6, further comprising:
an Access Point interface connecting the Labeled Analog Burst Switching Node to PDU devices such as electronic label switching routers,
a Burst assembly unit, and
a Signal Channel Multiplexed Analog Burst Switch comprising an Analog Burst Switching Fabric and its controller, an input interface and an output interface; and
a control packet processing unit connected to the Signal Channel Multiplexed Analog Burst Switch, said processing unit utilizing as the control platform Multi-Protocol Label Switching in conjunction with LABS specific extensions.

10. A Labeled Analog Burst Switching Node for network communications according to claim 6, further comprising:
an Access Point interface connecting the Labeled Analog Burst Switching Node to PDU devices such as electronic label switching routers,
a Burst dis-assembly unit, and
a Signal Channel Multiplexed Analog Burst Switch comprising an Analog Burst Switching Fabric and its controller, an input interface and an output interface; and
a control packet processing unit connected to the Signal Channel Multiplexed Analog Burst Switch, said processing unit utilizing as the control platform Multi-Protocol Label Switching in conjunction with LABS specific extensions.

11. An optical network comprised of at least one Labeled Analog Burst Switching Nodes according to claim 7 and at least one LABS node according to claim 8.

12. A method for transmitting data over an optical network according to claim 1, in which the optical burst switching control packet, comprises a field for Label as defined in the Multi-Protocol Label Switching protocol, at least one other field as defined in said protocol, and at least one LABS specific field selected from the group consisting of Burst length, basic offset time, extra offset time, control packet arrival time, control packet departure time, error detecting/correcting code, ingress LABS node address and egress LABS node address.

13. A network for the transmission of data according to claim 4, in which protocol data units or data packets from PDU devices such as electronic label switching routers are assembled into optical bursts at an ingress LABS node, and then delivered, in an optical burst switched mode, to an egress LABS node, without going through an propagation delaying devices at intermediate LABS nodes.

14. A network for the transmission of data according to claim 4, in which packets going to the same egress Labeled Analog Burst Switching node are assembled into at least one burst according to the packet's Class of Service.

15. A network for the transmission of data according to claim 4, in which for one or more Classes of Service, the assembly time of a burst is limited according to the minimum value of the maximum delay budget of the packets assembled in the burst.

16. A network for the transmission of data according to claim 4, in which for one or more Classes of Service, the assembly of a burst is completed once the length of the burst as measured in bits, bytes or transmission time, exceeds a threshold.

17. A network for the transmission of data according to claim 4, in which burst profile information is distributed pertaining to each link in a Labeled Analog Burst Switched Network to establish one or more LABS paths according to the distributed burst profile information.

18. A network for the transmission of data according to claim 4, wherein at least one backup LABS path for at least one primary path is established, and at least one copy of at least one lost data burst or portion thereof is sent via at least one such backup LABS path.

19. A network for the transmission of data according to claim 4, in which a method for the detection and localization of faults in LABS networks comprising electronic monitoring on designated LABS control channels is implemented.
